(19) United States
(12) Patent Application Publication
(10) Pub. No.: US 2014/0105503 A1
(43) Pub. Date: Apr. 17, 2014

(54) ELECTRONIC APPARATUS AND HANDWRITTEN DOCUMENT PROCESSING METHOD

(71) Applicant: KABUSHIKI KAISHA TOSHIBA, Tokyo (JP)

(72) Inventor: Shigeru MOTOI, Kokubunji-shi (JP)

(73) Assignee: KABUSHIKI KAISHA TOSHIBA, Tokyo (JP)

(21) Appl. No.: 13/763,195

(22) Filed: Feb. 8, 2013

(30) Foreign Application Priority Data
Oct. 15, 2012 (JP) 2012-227880

(51) Int. Cl. G06K 9/00

(52) U.S. Cl. CPC G06K 9/00402
USPC 382/187

(57) ABSTRACT

According to one embodiment, an electronic apparatus includes a storing module and a display controller. The storing module stores a plurality of handwritten document data in a storage medium, each of the handwritten document data including stroke data corresponding to strokes, and region data indicative of a first region set for one or more first strokes of the plurality of strokes, the first strokes corresponding to a symbol. The display controller displays, if the plurality of handwritten document data are searched by a search key and the search key corresponds to the symbol, a list of first regions in the plurality of handwritten document data, the first regions corresponding to the symbol.

### CROSS-REFERENCE TO RELATED APPLICATIONS

This application is based upon and claims the benefit of priority from Japanese Patent Application No. 2012-227880, filed Oct. 15, 2012, the entire contents of which are incorporated herein by reference.

### FIELD

Embodiments described herein relate generally to an electronic apparatus which can process a handwritten document and a handwritten document processing method used in the electronic apparatus.

### BACKGROUND

In recent years, various electronic apparatuses such as tablets, PDAs, and smartphones have been developed. Most of electronic apparatuses of this type include touch screen displays so as to facilitate user's input operations.

When the user touches a menu or object displayed on the touch screen display with the finger or the like, he or she can instruct the electronic apparatus to execute a function associated with the touched menu or object.

Some of such electronic apparatuses have a function of allowing the user to handwrite characters, figures, and the like on the touch screen display. A handwritten document (handwritten page) including such handwritten characters and figures is stored, and is browsed as needed.

However, when many handwritten documents are stored, it is difficult to find out a handwritten document one wants to browse from these handwritten documents. For this reason, various methods of performing a search based on a handwritten character or figure have been proposed.

When handwritten documents are searched by a search key such as a character or figure, for example, handwritten documents including that search key are respectively previewed. In this case, the user may have to distinguish a scope related to the search key from each of the displayed handwritten documents. Since the user unwantedly browses portions which are not related to the search key in a handwritten document, he or she may have to spend much time until he or she can reach target information in the handwritten document.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic apparatus according to an embodiment.

FIG. 2 is a view showing an example of a handwritten document to be processed by the electronic apparatus of the embodiment.

FIG. 3 is an exemplary view for explaining time-series information corresponds to the handwritten document shown in FIG. 2, the time-series being stored in a storage medium by the electronic apparatus of the embodiment.

FIG. 4 is an exemplary block diagram showing the system configuration of the electronic apparatus of the embodiment.

FIG. 5 is an exemplary block diagram showing the functional configuration of a digital notebook application program executed by the electronic apparatus of the embodiment.

FIG. 6 is a view showing an example of a handwritten document includes handwritten figures, the handwritten document being processed by the electronic apparatus of the embodiment.

FIG. 7 is a view showing a preview example of entire handwritten documents acquired as a search result of a handwritten document search based on a search key.

FIG. 8 is a view showing a display example of search key portions in the acquired handwritten documents as a search result of the handwritten document search based on the search key.

FIG. 9 is a view showing a display example of fixed-length regions including the search key of the acquired handwritten documents as a search result of the handwritten document search based on the search key.

FIG. 10 is a view showing an example of regions associated with a specific figure in a handwritten document set by the electronic apparatus of the embodiment.

FIG. 11 is a view showing an example of a search result displayed by the electronic apparatus of the embodiment.

FIG. 12 is a view for explaining an example in which a designated region in a handwritten document is associated with a specific figure in the electronic apparatus of the embodiment.

FIG. 13 is a view for explaining another example in which a designated region in a handwritten document is associated with a specific figure in the electronic apparatus of the embodiment.

FIG. 14 is an exemplary flowchart showing the procedure of handwriting input processing executed by the electronic apparatus of the embodiment.

FIG. 15 is an exemplary flowchart showing the procedure of region setting processing executed by the electronic apparatus of the embodiment.

FIG. 16 is an exemplary flowchart showing the procedure of search processing executed by the electronic apparatus of the embodiment.

### DETAILED DESCRIPTION

Various embodiments will be described hereinafter with reference to the accompanying drawings.

In general, according to one embodiment, an electronic apparatus includes a storing module and a display controller. The storing module is configured to store a plurality of handwritten document data in a storage medium, each of the handwritten document data including a plurality of stroke data corresponding to a plurality of strokes, and region data indicative of a first region set for one or more first strokes of the plurality of strokes, the first strokes corresponding to a first symbol. The display controller is configured to display, if the plurality of handwritten document data are searched by a search key and the search key corresponds to the first symbol, a list of first regions in the plurality of handwritten document data, the first regions corresponding to the first symbol.

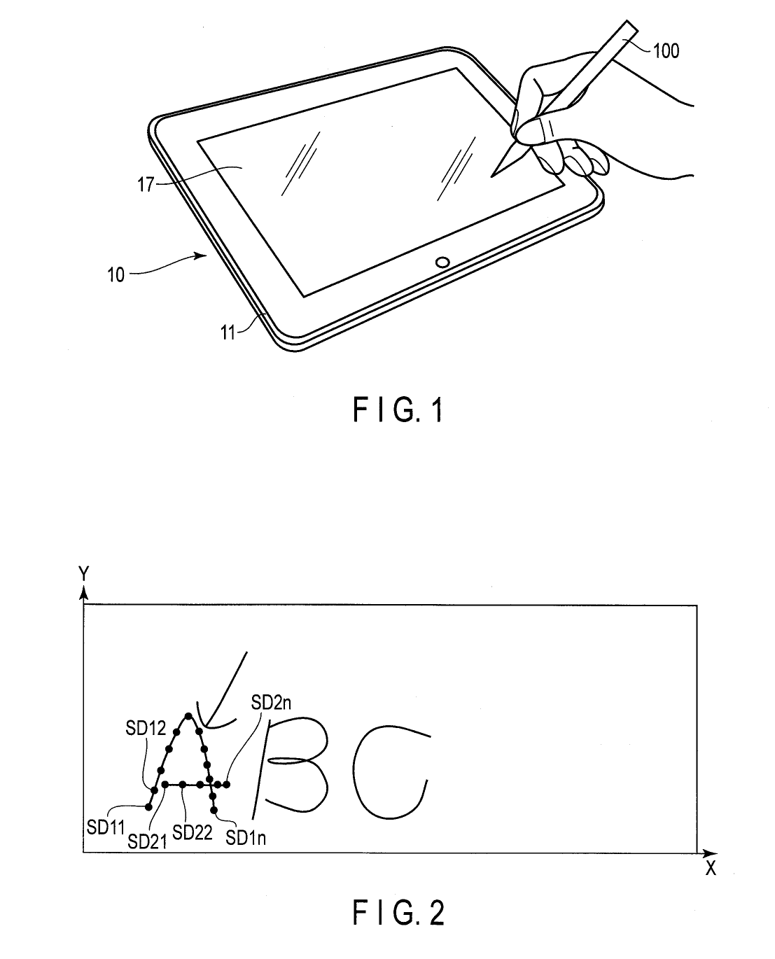

FIG. 1 is a perspective view showing the external appearance of an electronic apparatus according to one embodiment. This electronic apparatus is, for example, a pen-based portable electronic apparatus which allows a handwriting input using a pen or the finger. This electronic apparatus can be implemented as a tablet computer, notebook-type personal computer, smartphone, PDA, and the like. The following description will be given under the assumption that this electronic apparatus is implemented as a tablet computer 10. The tablet computer 10 is a portable electronic apparatus which is also called a tablet or slate computer, and includes a main body 11 and touch screen display 17, as shown in FIG. 1. The touch screen display 17 is attached to be overlaid on the upper surface of the main body 11.

The main body 11 has a thin box-shaped housing. The touch panel screen 17 incorporates a flat panel display and a sensor which is configured to detect a touch position of a pen or finger on the screen of the flat panel display. The flat panel display may be, for example, a liquid crystal display (LCD). As the sensor, for example, a touch panel of a capacitance type, a digitizer of an electromagnetic induction type, or the like can be used. The following description will be given under the assumption that both the two types of sensors, that is, the digitizer and touch panel are incorporated in the touch screen display 17.

Each of the digitizer and touch panel is arranged to cover the screen of the flat panel display. This touch screen display 17 can detect not only a touch operation on the screen using the finger but also that on the screen using a pen 100. The pen 100 may be, for example, an electromagnetic induction pen.

The user can make a handwriting input operation on the touch screen display 17 using an external object (pen 100 or finger). During the handwriting input operation, a path of movement of the external object (pen 100 or finger), that is, a path (handwriting) of a stroke handwritten by the handwriting input operation on the screen is drawn in real-time, thereby displaying the path of each stroke on the screen. The path of the movement of the external object while the external object is in contact with the screen corresponds to one stroke. A number of sets of strokes corresponding to a handwritten character or figure, that is, a number of sets of paths (handwriting) configure a handwritten document.

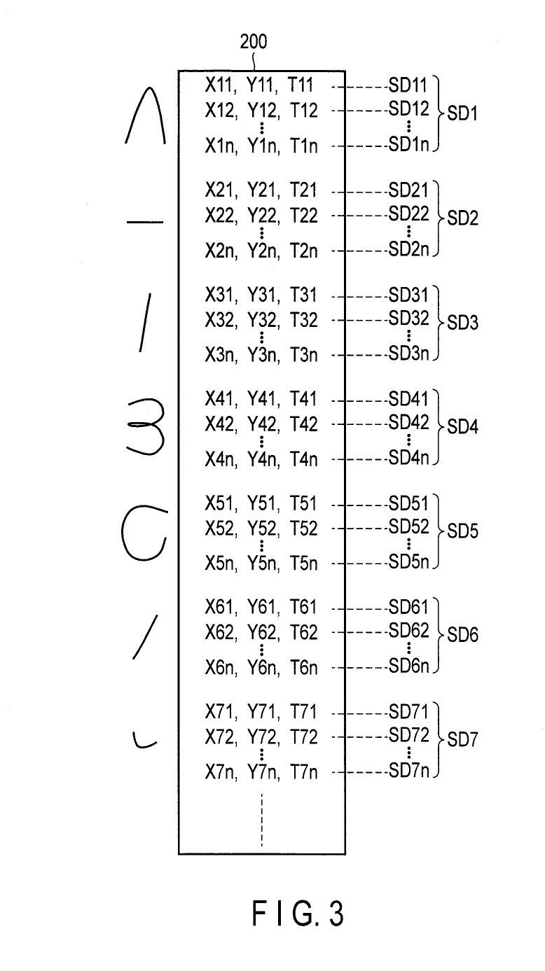

In this embodiment, this handwritten document is stored in a storage medium not as image data but as handwritten document data including coordinate sequences of paths of respective strokes and time-series information indicative of an order relation between strokes. Details of this time-series information will be described in detail later with reference to FIG. 3. This time-series information generally means a set of time-series stroke data corresponding to a plurality of strokes. Each stroke data corresponds to one stroke, and includes a coordinate data sequence (time-series coordinates) corresponding to respective points on a path of this stroke. An arrangement order of these stroke data corresponds to a handwriting order of respective strokes, that is, a stroke order.

The tablet computer 10 can read existing arbitrary handwritten document data from the storage medium, and can display, on the screen, a handwritten document corresponding to this handwritten document data. That is, the tablet computer 10 can display a handwritten document on which paths corresponding to a plurality of strokes indicated by time-series information are drawn.

The relationship between strokes (a character, mark, symbol, figure, table, and the like) handwritten by the user and the time-series information will be described below with reference to FIGS. 2 and 3. FIG. 2 shows an example of a handwritten document (handwritten character string) handwritten on the touch screen display 17 using the pen 100 or the like.

In a handwritten document, still another character, figure, or the like is handwritten above already handwritten characters, figures, or the like. FIG. 2 assumes a case in which a handwritten character string “ABC” is handwritten in an order of “A”, “B”, and “C”, and a handwritten arrow is then handwritten in the vicinity of a handwritten character “A”.

The handwritten character “A” is expressed by two strokes (a path of a “Λ” shape and that of a “-” shape) handwritten using the pen 100 or the like, that is, two paths. The “Λ”-shaped path of the pen 100, which is handwritten first, is sampled in real-time at, for example, equal time intervals, thereby obtaining time-series coordinates SD11, SD12, . . . , SD1n of the “Λ”-shaped stroke. Likewise, the “-”-shaped path of the pen 100, which is handwritten next, is sampled, thereby obtaining time-series coordinates SD21, SD22, . . . , SD2n of a “-”-shaped stroke.

The handwritten character “B” is expressed by two strokes handwritten using the pen 100 or the like, that is, two paths. The handwritten character “C” is expressed by one stroke handwritten using the pen 100 or the like, that is, one path. The handwritten “arrow” is expressed by two strokes handwritten using the pen 100 or the like, that is, two paths.

FIG. 3 shows time-series information 200 corresponding to the handwritten document shown in FIG. 2. The time-series information includes a plurality of stroke data SD1, SD2, . . . , SD7. In the time-series information 200, these stroke data SD1, SD2, . . . , SD7 are time-serially arranged in a stroke order, that is, a handwritten order of a plurality of strokes.

In the time-series information 200, the first and second stroke data SD1 and SD2 respectively indicate two strokes of the handwritten character “A”. The third and fourth stroke data SD3 and SD4 respectively indicate two strokes of the handwritten character “B”. The fifth stroke data SD5 indicates one stroke of the handwritten character “C”. The sixth and seventh stroke data SD6 and SD7 respectively indicate two strokes of the handwritten arrow.

Each stroke data includes a coordinate data sequence (time-series coordinates) corresponding to one stroke, that is, a plurality of coordinates corresponding to a plurality of points on a path of one stroke. In each stroke data, the plurality of coordinates are time-serially arranged in an order that stroke was written. For example, as for the handwritten character “A”, the stroke data SD1 includes a coordinate data sequence (time-series coordinates) corresponding to respective points on the path of the “Λ”-shaped stroke of the handwritten character “A”, that is, n coordinate data SD11, SD12, . . . , SD1n. The stroke data SD2 includes a coordinate data sequence corresponding to respective points on the path of the “-”-shaped stroke of the handwritten character “A”, that is, n coordinate data SD21, SD22, . . . , SD2n. Note that the number of coordinate data may be different for each stroke data.

Each coordinate data indicates X and Y coordinates corresponding to one point in the corresponding path. For example, the coordinate data SD11 indicates an X coordinate (X11) and Y coordinate (Y11) of a start point of the “Λ”-shaped stroke. Also, the coordinate data SD1n indicates an X coordinate (X1n) and Y coordinate (Y1n) of an end point of the “ΛA”-shaped stroke.

Furthermore, each coordinate data may include time stamp information T indicative of a handwritten timing of a point corresponding to that coordinate data. The handwritten timing may be either an absolute time (for example, year, month, day, hour, minute, second) or a relative time with reference to a certain timing. For example, an absolute time (for example, year, month, day, hour, minute, second) at which a stroke began to be written may be added to each stroke data as time stamp information, and a relative time indicative of a difference from the absolute time may be added to each coordinate data in that stroke data as the time stamp information T.

In this way, using the time-series information in which the time stamp information T is added to each coordinate data, the temporal relationship between strokes can be precisely expressed.

Information (Z) indicative of a writing pressure may be added to each coordinate data.

Furthermore, in this embodiment, since a handwritten document is stored as the time-series information 200 including sets of time-series stroke data in place of an image or character recognition results, as described above, handwritten characters and figures can be handled independently of languages. Hence, the structure of the time-series information 200 of this embodiment can be commonly used in various countries using different languages around the world.

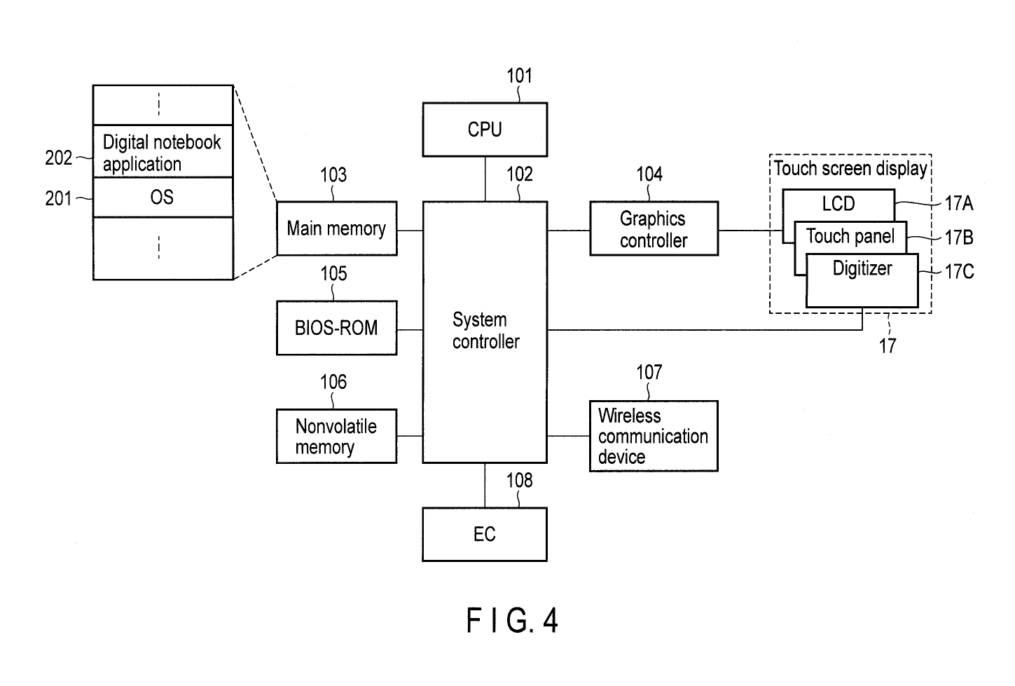

FIG. 4 shows the system configuration of the tablet computer 10.

As shown in FIG. 4, the tablet computer 10 includes a CPU 101, a system controller 102, a main memory 103, a graphics controller 104, a BIOS-ROM 105, a nonvolatile memory 106, a wireless communication device 107, an embedded controller (EC) 108, and the like.

The CPU 101 is a processor, which controls operations of various components in the tablet computer 10. The CPU 101 executes various software programs which are loaded from the nonvolatile memory 106 as a storage device onto the main memory 103. These software programs include an operating system (OS) 201 and various application programs. The application programs include a digital notebook application program 202. This digital notebook application program 202 has a function of creating and displaying the aforementioned handwritten document, a function of associating a designated region (scope) in a handwritten document with a specific figure or specific character string in the handwritten document, a function of searching handwritten documents, and the like.

The CPU 101 also executes a basic input/output system (BIOS) stored in the BIOS-ROM 105. The BIOS is a program required for hardware control.

The system controller 102 is a device which connects a local bus of the CPU 101 and various components. The system controller 102 also incorporates a memory controller which controls accesses to the main memory 103. The system controller 102 also has a function of executing communications with the graphics controller 104 via, for example, a PCI EXPRESS serial bus.

The graphics controller 104 is a display controller which controls an LCD 17A used as a display monitor of this tablet computer 10. A display signal generated by this graphics controller 104 is sent to the LCD 17A. The LCD 17A displays a screen image based on the display signal. On this LCD 17A, a touch panel 17B and digitizer 17C are arranged. The touch panel 17B is a capacitance type pointing device used to allow the user to make an input on the screen of the LCD 17A. The touch panel 17B detects a touch position of the finger on the screen, a movement of the touch position, and the like. The digitizer 17C is an electromagnetic induction type pointing device used to allow the user to make an input on the screen of the LCD 17A. The digitizer 17C detects a touch position of the pen 100 on the screen, a movement of the touch position, and the like.

The wireless communication device 107 is a device configured to execute wireless communications such as wireless LAN or 3G mobile communications. The EC 108 is a one-chip microcomputer including an embedded controller required for power management. The EC 108 has a function of turning on/off the power supply of this tablet computer 10 in response to an operation of a power button by the user.

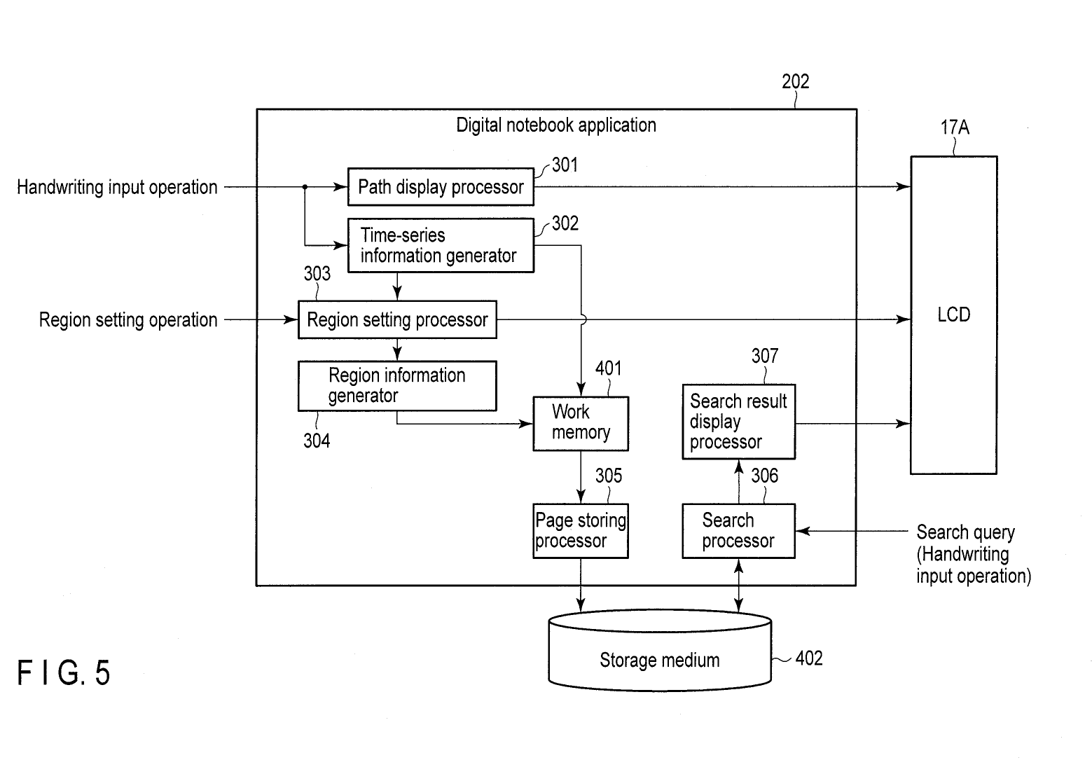

The functional configuration of the digital notebook application program 202 will be described below with reference to FIG. 5. The digital notebook application program 202 executes creation, displaying, editing, and the like of a handwritten document using stroke data input by handwriting input operation using the touch screen display 17. Also, the digital notebook application program 202 associates one or more strokes corresponding to a specific figure (or a specific character string) with a designated region (scope) in a handwritten document according to an operation for designating the region in the handwritten document using the touch screen display 17. Furthermore, the digital notebook application program 202 searches handwritten documents according to an input search query (search key), and displays a search result.

The digital notebook application program 202 includes, for example, a path display processor 301, time-series information generator 302, region setting processor 303, region information generator 304, page storing processor 305, search processor 306, search result display processor 307, and the like.

The touch screen display 17 is configured to generate events “touch”, “move (slide)”, “release”, and the like. The “touch” event indicates that the external object touched on the screen. The “move (slide)” event indicates that a touch position was moved while the external object touched on the screen. The “release” event indicates that the external object was released from the screen.

Modules required to process handwriting input operations in the digital notebook application program 202 will be described first.

The path display processor 301 and time-series information generator 302 receive the “touch” or “move (slide)” event generated by the touch screen display 17, thereby detecting a handwriting input operation. The “touch” event includes coordinates of a touch position. The “move (slide)” event includes coordinates of a touch position of a move destination. Therefore, the path display processor 301 and time-series information generator 302 can receive a coordinate sequence corresponding to a path of a movement of a touch position from the touch screen display 17.

The path display processor 301 receives a coordinate sequence from the touch screen display 17, and displays, on the screen of the LCD 17A in the touch screen display 17, a path of each stroke handwritten by a handwriting input operation using the pen 100 or the like based on this coordinate sequence. This path display processor 301 draws a path of the pen 100 while the pen 100 touches on the screen, that is, that of each stroke on the screen of the LCD 17A.

The time-series information generator 302 receives the aforementioned coordinate sequence output from the touch screen display 17. Then, the time-series information generator 302 generates time-series information (a plurality of stroke data corresponding to a plurality of strokes) having the structure described in detail above using FIG. 3 based on this coordinate sequence. In this case, the time-series information, that is, coordinates and time stamp information corresponding to respective points of strokes may be temporarily stored in a work memory 401.

With the above modules, the user can create a handwritten document including handwritten characters and figures, and can also input a handwritten character or figure used as a search key.

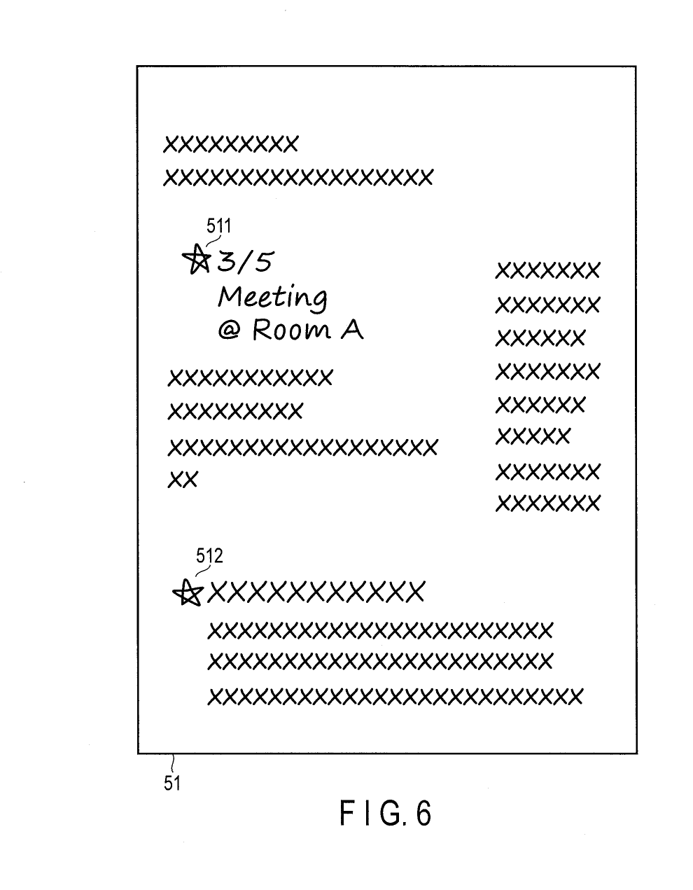

FIG. 6 shows an example of a handwritten document including handwritten figures. A handwritten document 51 shown in FIG. 6 describes handwritten FIGS. 511 and 512 in addition to handwritten character strings. In such handwritten document 51, not only a search based on a character (character string) but also that based on a figure can be performed.

The user handwrites specific figures (for example, stars, double circles, and the like) 511 and 512 on regions that describe important descriptions in the handwritten document 51, so that these regions are recognized while being distinguished from other regions. Thus, when the user reads, for example, that handwritten document 51 over again, he or she finds the specific FIGS. 511 and 512 in the handwritten document 51, and can easily confirm important descriptions in that handwritten document 51 by reading the descriptions in the vicinity of these figures. The specific figure will be exemplified below. However, the embodiment is not limited to this, and any other symbols (specific symbol) may be used as long as they are specified on the system or the user. The specific symbol is not particularly limited as long as it serves as a mark when the user browses a handwritten document, and includes a character (including a language), code, emblem, and the like.

In a handwritten document search, handwritten documents are searched by the aforementioned specific figure, thereby retrieving, for example, handwritten documents including important descriptions.

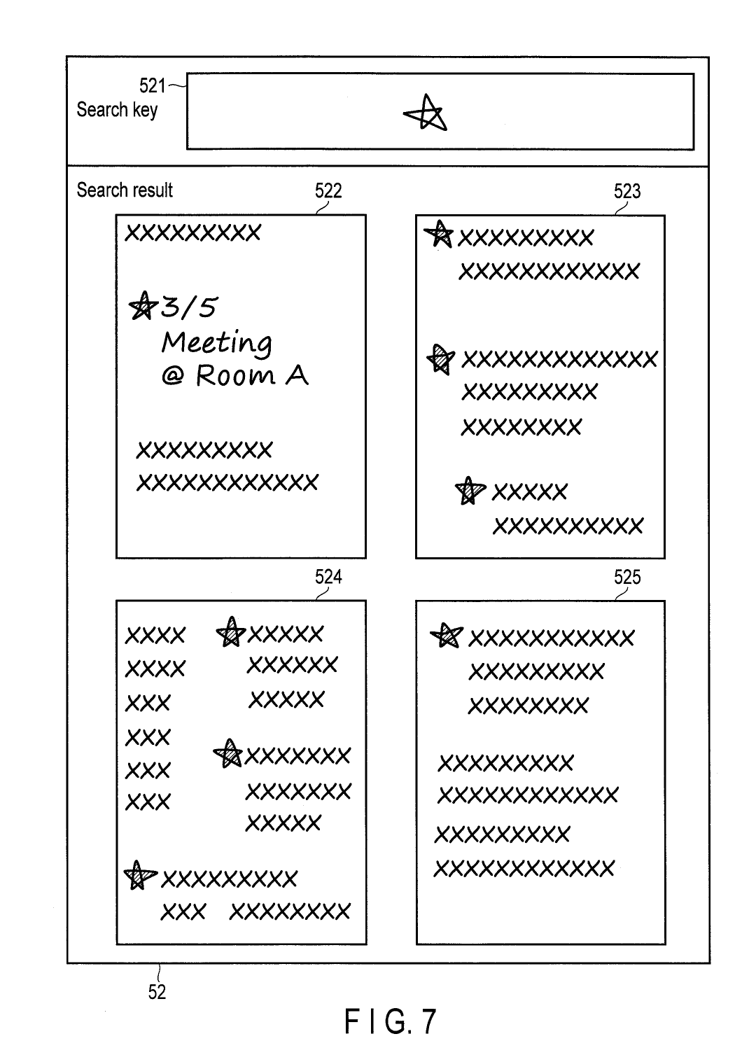

FIGS. 7, 8, and 9 show examples of search screens in the handwritten document search by a handwritten figure. Assume that on search screens 52, 53, and 54 shown in FIGS. 7, 8, and 9, a star figure is handwritten in search key input areas 521, 531, and 541, and a search result of handwritten documents based on this star figure is displayed.

On the search screen 52 shown in FIG. 7, as a search result of handwritten documents based on the star figure as a search key, a list of handwritten documents including the star figure is displayed. In this list, thumbnails 522, 523, 524, and 525 corresponding to entire pages of the handwritten documents including the star figures are arranged to be previewed. Also, portions corresponding to the search key (that is, the star figure) in the thumbnails 522, 523, 524, and 525 are highlighted.

With this search screen 52, the user can browse the thumbnails of the handwritten documents including the handwritten figure as the search key. However, since this search screen 52 displays the thumbnails corresponding to the entire pages of the handwritten documents, not only regions related to the search key but also those poorly related to the search key are displayed.

For this reason, even when the user handwrites star figures at positions corresponding to the important descriptions in handwritten documents and searches the handwritten documents using that star figure as a search key, not portions corresponding to the important descriptions, but the entire pages are displayed. To display the entire handwritten pages including the star figures may often be redundant for browsing by the user.

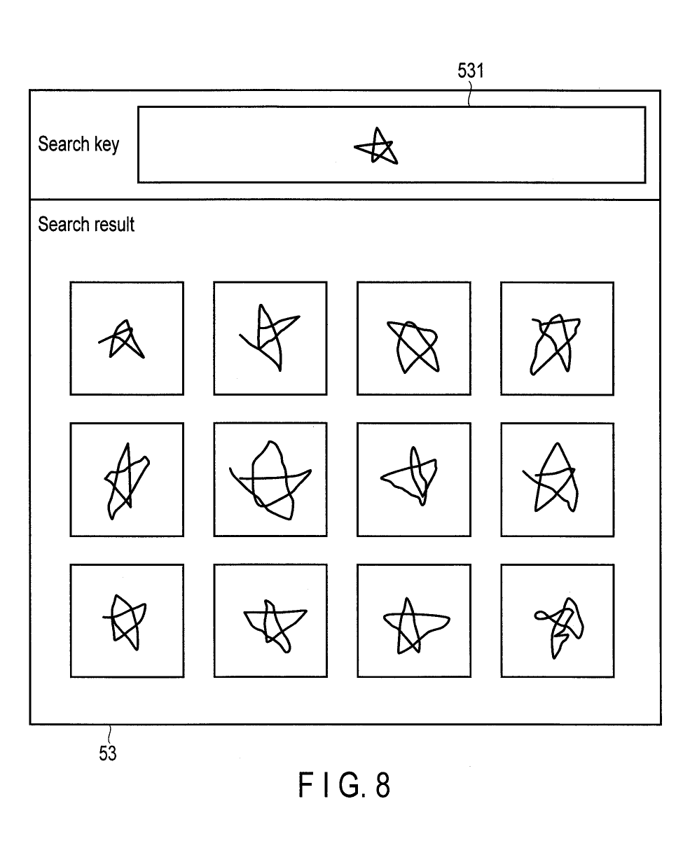

The search screen 53 shown in FIG. 8 is a display example of a list of star figures in a plurality of handwritten documents as a search result of handwritten documents based on the star figure as a search key.

In the list including only star figures as the search key, the user can only browse the star figures. Then, in order to browse a portion including important descriptions in a handwritten document in which the star figure was handwritten, the user has to select, for example, each of these star figures displayed in the list to display a handwritten document (handwritten page) including the displayed star figure. This is a troublesome operation for the user.

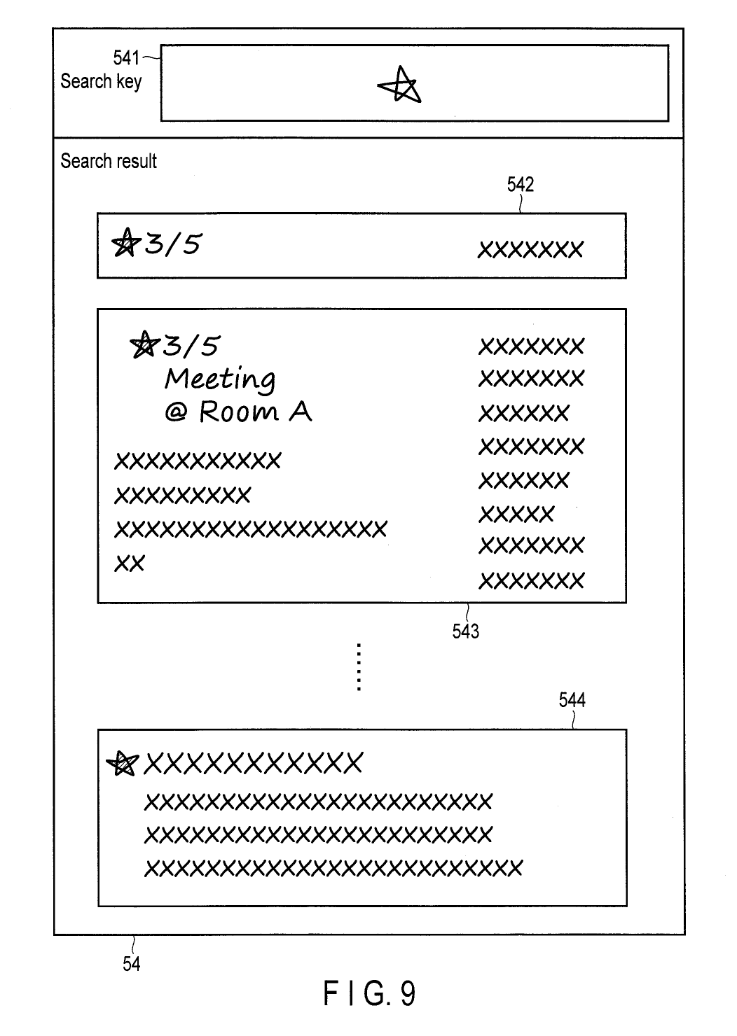

Furthermore, the search screen 54 shown in FIG. 9 is a display example of a list of fixed-length regions including star figures in a plurality of handwritten documents as a search result of handwritten documents based on the star figure as the search key. This fixed-length region is defined by, for example, the number of lines, the number of paragraphs, the number of pixels, and the like.

For example, a region 542 in the search result is a region having the predetermined number of lines (for example, one line) including the star figure. A region 543 is a region having the predetermined number of pixels (for example, 600 pixels in the horizontal direction×400 pixels in the vertical direction) including the star figure. Also, a region 544 is a region having the predetermined number of paragraphs (for example, one paragraph) including the star figure.

However, such fixed-length regions may have excess or deficiency for regions that the user wants to browse. For example, in the fixed-length region, a portion that includes the important descriptions in a handwritten document including the handwritten star figure may be partially omitted, or a portion other than that corresponding to the important descriptions in a handwritten document is also included, and such fixed-length region may be redundant for browsing by the user.

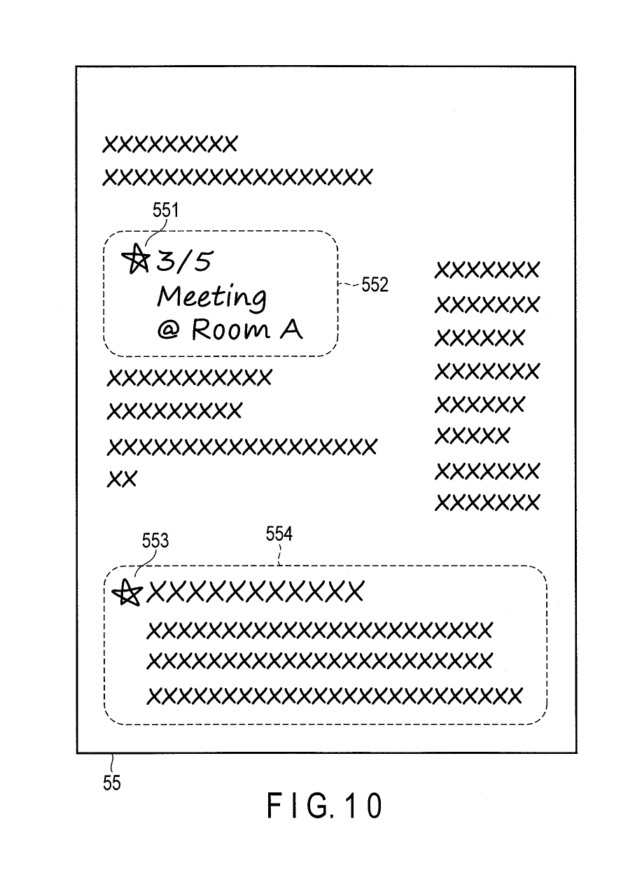

For this reason, in this embodiment, as shown in FIG. 10, regions 552 and 554 designated by the user are set for strokes corresponding to specific figures (star figures in the example of FIG. 10) 551 and 553 which are handwritten in a handwritten document 55. The user handwrites, for example, the star FIG. 551, and makes an operation for designating the region 552 including descriptions to be associated with this star FIG. 551. Likewise, the user handwrites the star FIG. 553, and makes an operation for designating the region 554 including descriptions to be associated with this star FIG. 553.

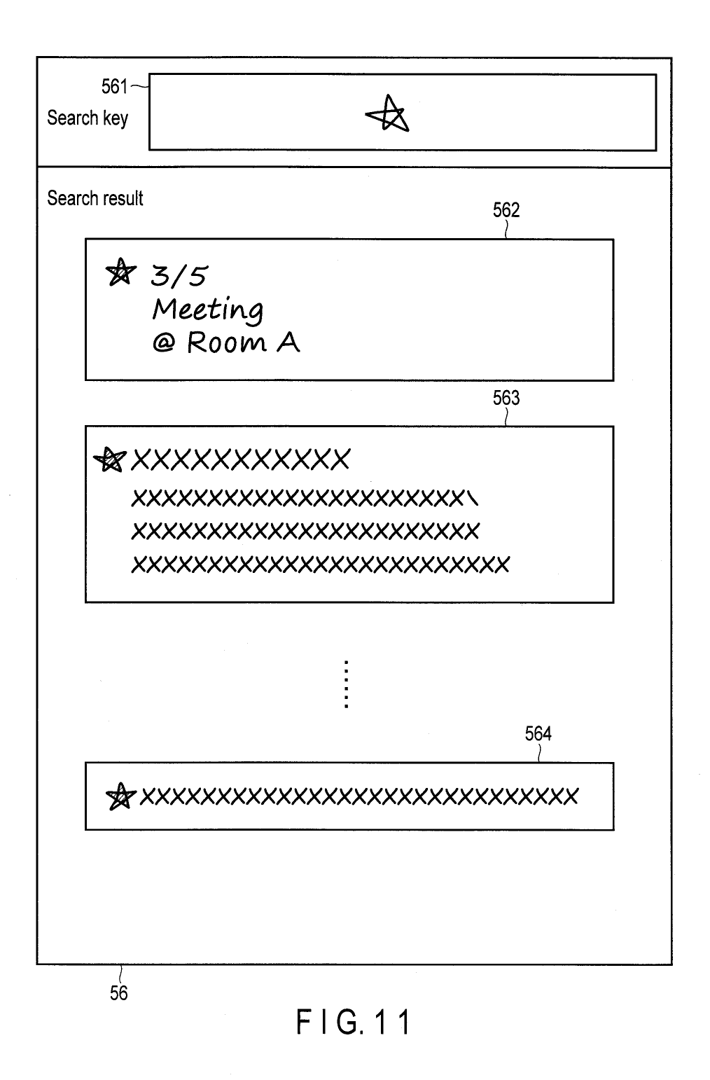

Then, like in a search screen 56 shown in FIG. 11, when the user inputs a star figure in a search key input area 561 and conducts a handwritten document search based on that star figure, a list of regions 562, 563, and 564 set for star figures in handwritten documents is displayed as a search result. Portions (that is, star figures) corresponding to the search key in the regions 562, 563, and 564 are highlighted. Thus, when a handwritten document search is performed based on the specific figure, the visibility and usability of the search result can be improved.

Modules required to set a region in a handwritten document for a stroke (or strokes) corresponding to a specific figure in the digital notebook application program 202 will be described below.

The region setting processor 303 detects a specific figure (first symbol) handwritten on a handwritten document, which is being created, using time-series information (stroke data) generated by the time-series information generator 302. This specific figure is a predefined figure (for example, a figure “star”, “double circle”, or the like), as described above, and feature amounts corresponding to a shape of that figure are stored in a storage medium 402. The storage medium 402 is, for example, a storage device in the tablet computer 10, and stores feature amounts corresponding to respective shapes of a plurality of figures defined as “specific figure”. This specific figure is handwritten on a handwritten document so as to clearly specify a region that the user intended to be distinguished from other regions like a region which describes important descriptions in a handwritten document.

More specifically, the region setting processor 303 reads feature amounts corresponding to the specific figure to be detected from the storage medium 402. The specific figure to be detected may include a plurality of figures. Next, the region setting processor 303 calculates feature amounts corresponding to a shape (a gradient of a stroke and the like) of one or more handwritten strokes using time-series information generated by the time-series information generator 302. Then, the region setting processor 303 determines that one or more strokes corresponding to that specific figure are detected when a similarity between the calculated feature amounts and those corresponding to the specific figure to be detected is equal to or higher than a threshold.

Upon detection of one or more strokes (first strokes) corresponding to the specific figure (first symbol), the region setting processor 303 displays a region designation object used to designate a region to be associated with the one or more strokes. This region designation object is not particularly limited as long as it can prompt the user to designate a region to be associated with the specific figure (specific symbol) or it allows the user to designate a region to be associated with the specific figure (specific symbol). This region designation object is, for example, an object used to designate a region on a handwritten document by a user operation using the touch screen display 17, and is drawn on the handwritten document as a dotted line or popup which represents the designated region. The region setting processor 303 displays, for example, the region designation object which includes one or more strokes corresponding to the specific figure. Alternatively, the region setting processor 303 may display the region designation object which includes a predetermined region including one or more strokes corresponding to the specific figure (for example, a predetermined region including strokes handwritten immediately before the one or more strokes).

The user adjusts a region to be associated with the one or more strokes corresponding to the handwritten specific figure by a region change operation for broadening or narrowing down this region designation object. For example, the user can adjust that region by an operation for dragging an end portion of the region designation object on the touch screen display 17.

Then, the region information generator 304 sets (associates) a region (first region) designated using the region designation object for (with) the one or more strokes corresponding to the specific figure in response to completion of the operation using the region designation object. More specifically, the region information generator 304 generates region data indicative of the designated region, and temporarily stores that region data in the work memory 401. This region data includes information (for example, stroke IDs) indicative of the one or more strokes corresponding to the specific figure and information indicative of a position and size on a handwritten document of the region designated using the region designation object. Thus, a designated region in a handwritten document can be stored in association with a certain specific figure. Note that the region information generator 304 determines completion of the operation using the region designation object, for example, when the operation using the region designation object is not detected for a predetermined period or when a new handwriting input operation is detected.

Furthermore, in response to an operation for touching (tapping) the specific figure for which the region has already been set on the touch screen display 17, the region setting processor 303 may display the region designation object representing the region which has already been set for that specific figure. In this case, the user can re-adjust the region set for the one or more strokes corresponding to that specific figure using the displayed region designation object. Also, the region information generator 304 updates corresponding region data based on the re-adjusted region.

The page storing processor 305 stores the generated time-series information (stroke data) and region data as a handwritten document (handwritten page) in the storage medium 402. The path display processor 301 can read arbitrary time-series information stored in the storage medium 402, can analyze that time-series information, and can display paths of respective strokes indicated by the time-series information as a handwritten page based on this analysis result.

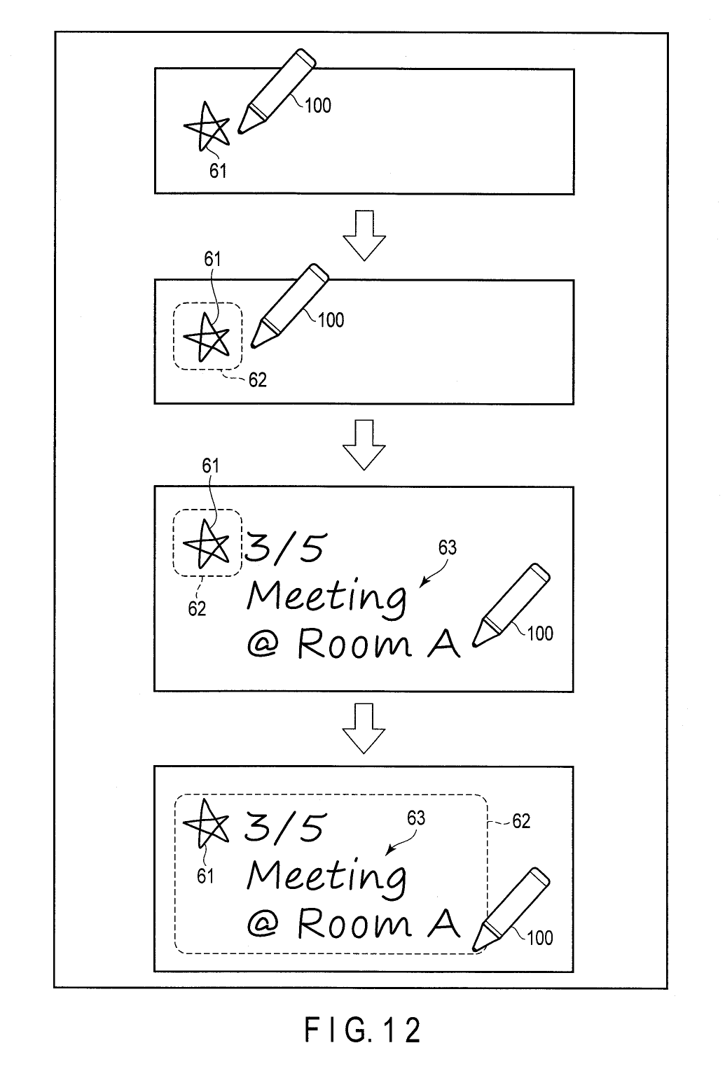

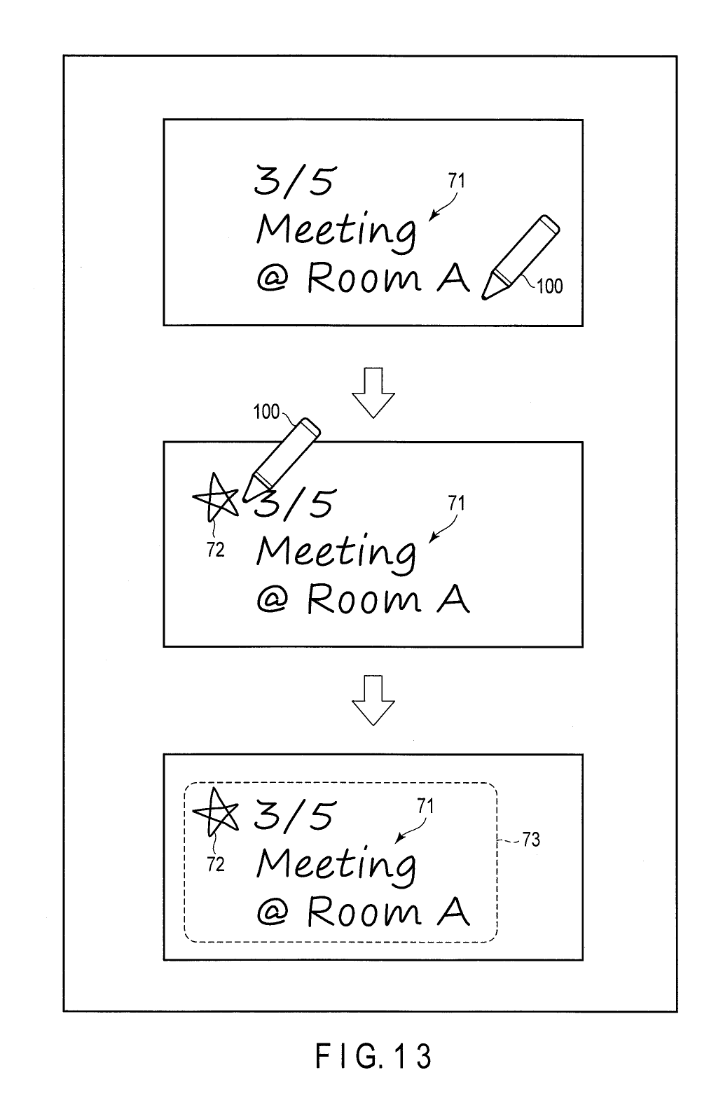

FIGS. 12 and 13 show examples of methods of associating a designated region in a handwritten document with one or more strokes corresponding to the handwritten specific figure.

FIG. 12 shows an example of a case in which after a specific figure is handwritten, a text or the like to be associated with that specific figure is handwritten.

The user handwrites a specific figure (star FIG. 61 on the touch screen display 17 using the pen 100 or the like.

The region setting processor 303 detects the handwritten specific FIG. 61, and then displays a region setting object 62 used to set a region on the display 17A. The region setting object 62 is a GUI required to allow the user to make a region setting operation. The region setting processor 303 displays the region setting object 62 to have a dotted line which surrounds the handwritten specific FIG. 61 as an initial value.

The user handwrites a text (character string) 63 to be associated with the handwritten specific FIG. 61. Then, the user makes an operation for changing the region setting object 62 (an operation for broadening or narrowing down the region setting object 62) so as to include the handwritten text 63 using the touch screen display 17.

Upon completion of the operation using the region setting object 62, the region setting processor 303 sets the region corresponding to the changed region setting object 62 (in this case, the region which includes the specific FIG. 61 and sentence 63) for the specific FIG. 61.

FIG. 13 shows an example of a case in which after a text is handwritten, a specific figure with which that text is to be associated is handwritten.

The user handwrites a text (character string) 71 on the touch screen display 17 using the pen 100 or the like. Then, the user handwrites a specific figure (star FIG. 72 to be associated with that text 71.

The region setting processor 303 detects the handwritten specific FIG. 72, and then displays a region setting object 73 required to set a region on the display 17A. As described above, the region setting object 73 is a GUI required to allow the user to make a region setting operation. The region setting processor 303 displays the region setting object 73 to have a dotted line which surrounds the specific FIG. 72 and the text handwritten in the vicinity of this specific FIG. 72 as an initial value.

More specifically, the region setting processor 303 determines using, for example, stroke data of strokes handwritten before the specific FIG. 72 whether or not the strokes have already been handwritten on the right or lower side of the specific FIG. 72. When the strokes have already been handwritten on the right or lower side of the specific FIG. 72, the region setting processor 303 displays the region setting object 73 which surrounds the FIG. 72 and these strokes. Note that when a delimiter of a region such as a comma, period, or space can be discriminated in the strokes handwritten on the right or lower side of the specific FIG. 72, the region setting object 73 which surrounds strokes up to that delimiter of the region may be displayed.

Furthermore, the user can also adjust the region to be set for the specific FIG. 72 by making an operation for changing the region setting object 73 (an operation for broadening or narrowing down the region setting object 73) using the touch screen display 17.

Upon completion of the operation using the region setting object 73, the region setting processor 303 sets a region corresponding to the region setting object 73 (in this case, a region including the specific FIG. 72 and text 71) for the specific FIG. 72.

Note that the region setting processor 303 may set a region including the predetermined number of strokes handwritten at least either before or after one or more strokes corresponding to a specific figure with respect to that specific figure. For example, the region setting processor 303 sets a region including 30 strokes handwritten immediately before one or more strokes corresponding to a specific figure and 70 strokes handwritten immediately after the one or more strokes with respect to the one or more strokes.

In this manner, the region setting processor 303 and region information generator 304 can set in advance a region in a handwritten document to be displayed as a search result upon retrieving the handwritten document based on a specific figure.

Modules required to search handwritten documents in the digital notebook application program 202 will be described below.

The search processor 306 searches a plurality of handwritten documents (for example, a plurality of handwritten document data stored in the storage medium 402) using a character string or figure configured by one or more strokes handwritten by a handwriting input operation as a search key. The search processor 306 retrieves a handwritten document including the character string or figure as the search key. More specifically, the search processor 306 calculates feature amounts corresponding to the search key (strokes) by analyzing stroke data (time-series information) of one or more strokes corresponding to the character string or figure as the search key. Then, the search processor 306 compares the calculated feature amounts of the search key with feature amounts of a character string or figure included in a handwritten document, which amounts are similarly calculated, and retrieves a handwritten document having the feature amounts similar to those of the search key.

The search result display processor 307 displays, for example, a list of thumbnails of retrieved handwritten documents on the display 17A.

Also, when the search key corresponds to the aforementioned specific figure (first symbol), the search processor 306 retrieves handwritten documents including that specific figure, and further detects regions (first regions) in the handwritten documents, which regions are set for (associated with) that specific figure.

More specifically, the search processor 306 reads feature amounts corresponding to the specific figure from the storage medium 402. Next, the search processor 306 calculates feature amounts corresponding to the search key using stroke data (time-series information) of the search key. Then, when a similarity between the calculated feature amounts of the search key and those corresponding to the specific figure is equal to or higher than a threshold, the search processor 306 determines that the search key is the specific figure.

When the search key is the specific figure, the search processor 306 retrieves a handwritten document including feature amounts similar to those of the search key, and reads region data corresponding to that handwritten document from the storage medium 402. The search processor 306 detects a region set for one or more strokes corresponding to the specific figure as the search key using the read region data. Note that when a plurality of such specific figures are handwritten in a handwritten document, the search processor 306 detects a plurality of regions respectively set for strokes corresponding to these plurality of specific figures.

The search result display processor 307 displays a list of regions (first regions), which are set for one or more strokes corresponding to the specific figure as the search key and are included in a plurality of handwritten document data, on the display 17A.

With the aforementioned modules, when handwritten documents are searched by the specific figure, for example, only a region including important descriptions can be displayed as a search result, and the user can easily recognize information displayed as the search result, thus improving the usability of a search.

Note that in the example of the above description, a region (first region) in a handwritten document is set for one or more strokes corresponding to a specific figure. Alternatively, a region (second region) in a handwritten document may be set for one or more strokes corresponding to a specific character string (first character string). In this case, when a plurality of handwritten documents are searched by a search key, and when that search key corresponds to the first character string (that is, when one or more strokes of the search key correspond to the first character string), the search processor 306 and search result display processor 307 display a list of second regions included in a plurality of handwritten document data on the display 17A.

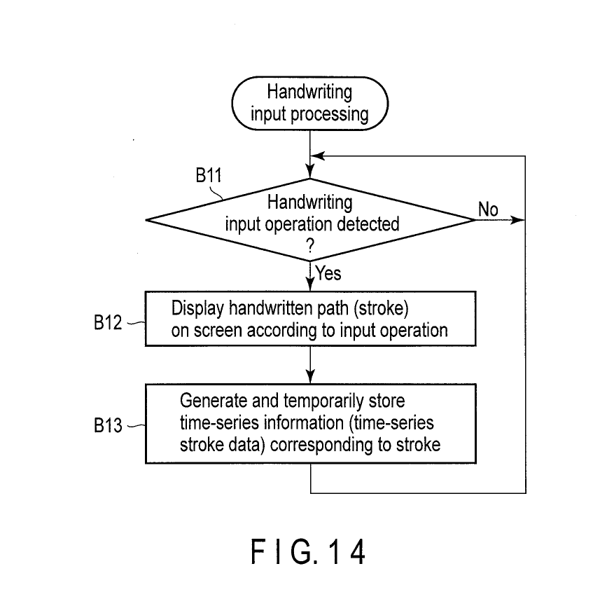

The procedure of handwriting input processing executed by the digital notebook application program 202 will be described below with reference to the flowchart shown in FIG. 14.

Initially, the path display processor 301 and time-series information generator 302 determine whether a handwriting input operation is detected (block B11). For example, when the user makes a handwriting input operation using the pen 100, “touch” and “move” events are generated. Based on these events, the path display processor 301 and time-series information generator 302 detect a handwriting input operation. If no handwriting input operation is detected (NO in block B11), the process returns to block B11, and the path display processor 301 and time-series information generator 302 determine again whether a handwriting input operation is detected.

If a handwriting input operation is detected (YES in block B11), the path display processor 301 displays a path (stroke) of a movement of the pen 100 or the like by the handwriting input operation on the display 17A (block B12). Furthermore, the time-series information generator 302 generates the aforementioned time-series information (stroke data) based on a coordinate sequence corresponding to the path by the handwriting input operation, and temporarily stores that time-series information in the work memory 401 (block B13).

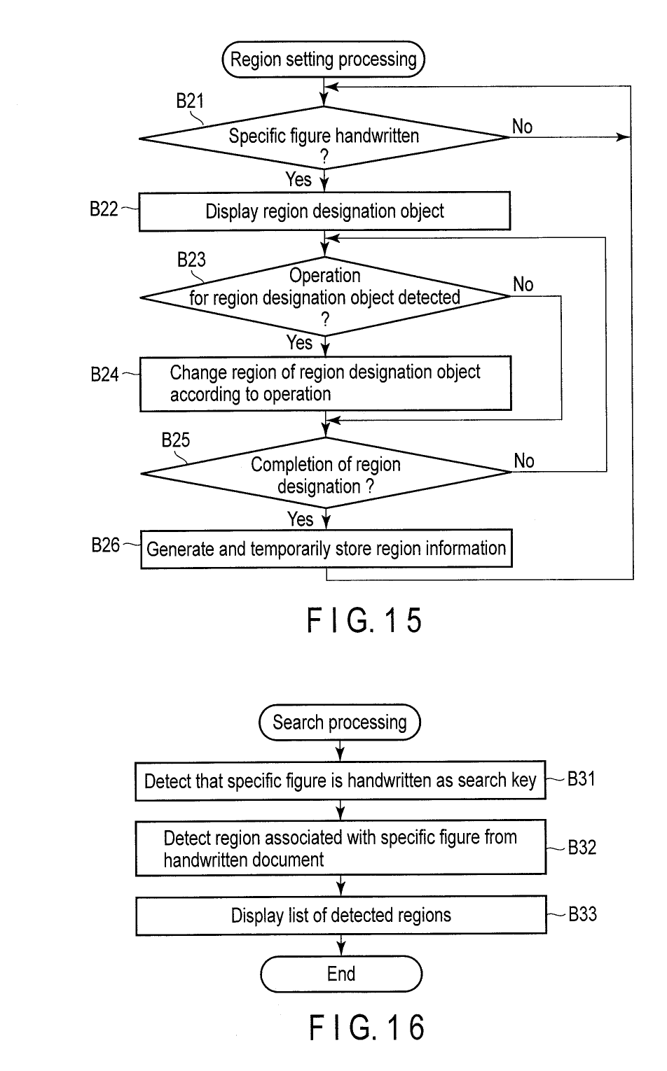

The procedure of region setting processing executed by the digital notebook application program 202 will be described below with reference to the flowchart shown in FIG. 15.

The region setting processor 303 determines using time-series information (a plurality of stroke data corresponding to a plurality of strokes) generated by the aforementioned time-series information generator 302 whether a specific figure (first symbol) is handwritten on a handwritten document which is being created (block B21). If no specific figure is handwritten (NO in block B21), the process returns to block B21, and the region setting processor 303 determines again whether a specific figure is handwritten.

On the other hand, if the specific figure is handwritten (YES in block B21), the region setting processor 303 displays a region designation object for designating a region to be associated with that specific figure (block B22). Then, the region setting processor 303 determines whether a region change operation for the region designation object is detected (block B23). If the region change operation is detected (YES in block B23), the region setting processor 303 changes a region of the region designation object according to that region change operation, and draws the changed region on the handwritten document (block B24). If no region change operation is detected (NO in block B23), the region setting processor 303 skips the process of block B24.

Next, the region setting processor 303 determines whether designation of the region is complete (block B25). If designation of the region is not complete yet (NO in block B25), the process returns to block B23 to execute processing corresponding to another region change operation.

On the other hand, if designation of the region is complete (YES in block B25), the region information generator 304 generates region data indicative of the designated region (first region) set for one or more strokes (first strokes) corresponding to the specific figure, and temporarily stores that region data in the work memory 401 (block B26). In this way, the designated region in the handwritten document can be stored in association with the handwritten specific figure.

An example of the procedure of search processing executed by the digital notebook application program 202 will be described below with reference to the flowchart shown in FIG. 16. The following description will be given under the assumption that a specific figure is input by handwriting as a search key used in a search.

Upon reception of a search request of handwritten documents, the search processor 306 detects that a specific figure (first symbol) is handwritten as a search key (block B31). Next, the search processor 306 detects a region in a handwritten document, which region is associated with one or more strokes corresponding to the detected specific figure using region data stored in the storage medium 402 (block B32). Then, the search result display processor 307 displays a list of detected regions in handwritten documents on the display 17A (block B33).

As described above, according to this embodiment, when handwritten documents are searched by a search key, the user can browse regions related to the search key in the handwritten documents. The region setting processor 303 sets (associates) a first region in a handwritten document for (with) one or more strokes corresponding to a first symbol (specific figure) among a plurality of strokes handwritten in that handwritten document. Then, if a plurality of handwritten documents are searched by a search key as one or more handwritten strokes and the one or more strokes of that search key correspond to a first symbol, the search processor 306 acquires first regions (that is, regions associated with the first symbol) in the plurality of handwritten documents. Thus, the user can browse regions related to the first symbol as the search key in the handwritten documents.

All the process procedures in this embodiment, which have been described with reference to the flowcharts of FIGS. 14 to 16, can be executed by software. Thus, the same advantageous effects as with the present embodiment can easily be obtained simply by installing a computer program, which executes the process procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic apparatus comprising:
a storing processor configured to store a plurality of document data in a storage medium, the plurality of document data comprising a plurality of stroke data corresponding to a plurality of strokes input by handwriting, and a plurality of region data set for specifying first regions associated respectively with one or more first strokes of the plurality of strokes, one or more first strokes corresponding to a first symbol, the first regions comprising respectively one or more first strokes and one or more second strokes of the plurality of strokes; and
a display controller configured to display, if the document data are searched by a handwritten stroke corresponds to the first symbol, a plurality of first regions in the plurality of document data on a screen simultaneously.

2. The apparatus of claim 1, further comprising a region setting module configured to set a region designated by a user as a second region of the first regions.

3. The apparatus of claim 2, wherein the region setting module is configured to display a region designation object for designating the second region on a handwritten document when the one or more first strokes corresponding to the first symbol are detected from a plurality of strokes input by handwriting, and to set the second region in accordance with an operation for designating a region by the user using the region designation object.

4. The apparatus of claim 3, wherein the operation for designating the second region by the user comprises an operation of broadening a region indicated by the region designation object or an operation of narrowing down the region using a touch screen display.

5. The apparatus of claim 3, wherein the region setting module is configured to display the region designation object comprising the one or more first strokes corresponding to the first symbol.

6. The apparatus of claim 3, wherein the region setting module is configured to display the region designation object which comprises a predetermined region comprising the one or more first strokes corresponding to the first symbol.

7. The apparatus of claim 1, wherein each of the plurality of document data further comprises a plurality of region data set for specifying the first regions associated respectively with the one or more first strokes corresponding to the first symbol, the first regions comprising respectively a predetermined number of strokes handwritten at least either before or after the one or more first strokes.

8. The apparatus of claim 1, wherein each of the plurality of document data further comprises a plurality of region data for specifying second regions associated respectively with one or more third strokes of the plurality of strokes, the one or more third strokes corresponding to a first character string, the second regions comprising respectively one or more third strokes and one or more fourth strokes of the plurality of strokes and
the display controller is configured to display a plurality of second regions in the plurality of document data on a screen simultaneously if the handwritten stroke corresponds to the first character string.

9. A handwritten document processing method comprising:
storing a plurality of document data in a storage medium, the plurality of document data comprising a plurality of stroke data corresponding to a plurality of strokes input by handwriting, and a plurality of region data set for specifying first regions associated respectively with one or more first strokes of the plurality of strokes, one or more first strokes corresponding to a first symbol, the first regions comprising respectively one or more first strokes and one or more second strokes of the plurality of strokes; and
displaying, if the document data are searched by a handwritten stroke corresponds to the first symbol, a plurality of first regions in the plurality of document data on a screen simultaneously.

10. A computer-readable, non-transitory storage medium having stored thereon a program which is executable by a computer, the program controlling the computer to execute functions of:
storing a plurality of document data in a storage medium, the plurality of document data comprising a plurality of stroke data corresponding to a plurality of strokes input by handwriting, and a plurality of region data set for specifying first regions associated respectively with one or more first strokes of the plurality of strokes, one or more first strokes corresponding to a first symbol, the first regions comprising respectively one or more first strokes and one or more second strokes of the plurality of strokes; and
displaying, if the document data are searched by a handwritten stroke corresponds to the first symbol, a plurality of first regions in the plurality of document data on a screen simultaneously.

11. The handwritten document processing method of claim 9, further comprising setting a region designated by a user as a second region of the first regions.

12. The handwritten document processing method of claim 11, wherein the displaying comprises displaying a region designation object for designating the second region on a handwritten document when the one or more first strokes corresponding to the first symbol are detected from a plurality of strokes input by handwriting, and setting the second region in accordance with an operation for designating a region by the user using the region designation object.

13. The handwritten document processing method of claim 12, wherein the operation for designating the second region by the user comprises an operation of broadening a region indicated by the region designation object or an operation of narrowing down the region using a touch screen display.

14. The handwritten document processing method of claim 12, wherein the displaying comprises displaying the region designation object comprising the one or more first strokes corresponding to the first symbol.

15. The handwritten document processing method of claim 12, wherein the displaying comprises displaying the region designation object which comprises a predetermined region comprising the one or more first strokes corresponding to the first symbol.

16. The handwritten document processing method of claim 9, wherein each of the plurality of document data further comprises a plurality of region data set for specifying the first regions associated respectively with the one or more first strokes corresponding to the first symbol, the first regions comprising respectively a predetermined number of strokes handwritten at least either before or after the one or more first strokes.

17. The handwritten document processing method of claim 9, wherein each of the plurality of document data further comprises a plurality of region data set for specifying second regions associated respectively with one or more third strokes of the plurality of strokes, the one or more third strokes corresponding to a first character string, the second regions comprising respectively one or more third strokes and one or more fourth strokes of the plurality of strokes and
the displaying comprises displaying a plurality of second regions in the plurality of document data on a screen simultaneously if the handwritten stroke corresponds to the first character string.

18. The storage medium of claim 10, wherein the program controls the computer to further execute functions of setting a region designated by a user as a second region of the first regions.

19. The storage medium of claim 18, wherein the setting comprises displaying a region designation object for designating the second region on a handwritten document when the one or more first strokes corresponding to the first symbol are detected from a plurality of strokes input by handwriting, and setting the second region in accordance with an operation for designating a region by the user using the region designation object.

20. The storage medium of claim 19, wherein the operation for designating the second region by the user comprises an operation of broadening a region indicated by the region designation object or an operation of narrowing down the region using a touch screen display.

21. The storage medium of claim 19, wherein the setting comprises displaying the region designation object comprising the one or more first strokes corresponding to the first symbol.

22. The storage medium of claim 19, wherein the setting comprises displaying the region designation object which comprises a predetermined region comprising the one or more first strokes corresponding to the first symbol.

23. The storage medium of claim 10, wherein each of the one or more document data further comprises a plurality of region data set for specifying the first regions associated respectively with the one or more first strokes corresponding to the first symbol, the first regions comprising respectively a predetermined number of strokes handwritten at least either before or after the one or more first strokes.

24. The storage medium of claim 10, wherein each of the plurality of document data further comprises a plurality of region data set for specifying second regions associated with one or more third strokes of the plurality of strokes, the one or more third strokes corresponding to a first character string, the second regions comprising respectively one or more third strokes and one or more fourth strokes of the plurality of strokes and
the displaying comprises displaying a plurality of second regions in the plurality of document data on a screen simultaneously if the handwritten stroke corresponds to the first character string.
